(19) United States
(12) Patent Application Publication
(10) Pub. No.: US 2026/0196718 A1
(43) Pub. Date: Jul. 9, 2026

(54) DECOUPLING DEVICE, ANTENNA SYSTEM WITH THE DECOUPLING DEVICE AND DECOUPLING METHOD THEREOF

(71) Applicant: Getac Technology Corporation, New Taipei City (TW)

(72) Inventor: Yu-Wei YE, Taipei City (TW)

(21) Appl. No.: 19/232,937

(22) Filed: Jun. 10, 2025

(30) Foreign Application Priority Data
Jan. 6, 2025 (TW) 114100490

(51) Int. Cl. H01Q 1/52; H01Q 1/48

(52) U.S. Cl. CPC H01Q 1/521; H01Q 1/48

(57) ABSTRACT

The decoupling device comprises a ground plate, a decoupling element, a switching element, and at least two matching circuits. The decoupling element is arranged between two adjacent antennas. The decoupling element and the two adjacent antennas are coupled to the ground plate. The switching element is disposed on the ground plate and coupled to the decoupling element. At least two matching circuits are disposed on the ground plate and are coupled to the switching elements respectively. The switching element is switched according to an operating frequency band of a communication element to couple one of at least two matching circuits to the decoupling element.

### RELATED APPLICATIONS

This is a U.S. Application, which claims priority to Taiwan Application Serial Number 114100490, filed Jan. 6, 2025, which is herein incorporated by reference.

### BACKGROUND

### Field of Invention

The present invention relates to an antenna system, and more particularly to a decoupling device, an antenna system using the decoupling device, and a decoupling method.

### Description of Related Art

Nowadays, electronic devices are designed to be light, thin, short and small, and therefore require a high screen-to-body ratio and narrow bezels. This design direction results in a smaller space available for antennas and the distance between antennas is getting closer and closer. When the distance between antennas is reduced, the antennas will interfere to each other if the antennas have the same frequency band. Furthermore, when the distance between the two antennas is too small, the current of one antenna will flow to the other antenna through the coupled ground plate, which causes the deterioration of antenna isolation.

Therefore, there is a need for a decoupling device, an antenna system and a decoupling method that can improve antenna isolation.

### SUMMARY

The foregoing presents a simplified summary of the disclosure in order to provide a basic understanding to the reader. This summary is not an extensive overview of the disclosure and it does not identify key/critical elements of the present disclosure or delineate the scope of the present disclosure.

One embodiment of the present invention is to provide a decoupling device for an antenna system. The decoupling device comprises a ground plate, a decoupling element, a switching element, and at least two matching circuits. The decoupling element is arranged between two adjacent antennas. The decoupling element and the two adjacent antennas are coupled to the ground plate. The switching element is disposed on the ground plate and coupled to the decoupling element. At least two matching circuits are disposed on the ground plate and are respectively coupled to the switching elements. The switching element is switched according to an operating frequency band of a communication element to couple one of at least two matching circuits to the decoupling element.

In some embodiments, the ground plate includes two grooves, and the decoupling element is separated from the two adjacent antennas by the two grooves respectively.

In some embodiments, each of the at least two matching circuits includes a filter circuit formed by at least one inductor and at least one capacitor in a T-shaped configuration or a π-shaped configuration.

In some embodiments, the two adjacent antennas are disposed on an antenna board. When the antenna board and the ground plate are assembled, the two adjacent antennas are coupled to the ground plate through two leaf springs on the ground plate.

In some embodiments, the decoupling device further includes a control element for detecting the operating frequency band of the communication element.

In some embodiments, when the control element detects that the operating frequency band of the communication element is a first frequency band, the switching element is switched to couple a first matching circuit of the at least two matching circuits to the decoupling element, and when the control element detects that the operating frequency band of the communication element is a second frequency band, the switching element is switched to couple a second matching circuit of the at least two matching circuits to the decoupling element.

Another embodiment of the present invention provides an antenna system. The antenna system includes a ground plate, at least two adjacent antennas, a decoupling element, a first switching element, a communication element, a control element, and at least two matching circuits. At least two adjacent antennas are coupled to the ground plate. The decoupling element is coupled to the ground plate and is disposed between the at least two adjacent antennas. The first switching element is disposed on the ground plate and coupled to the decoupling element. At least two matching circuits are disposed on the ground plate and are respectively coupled to the first switching element. The communication element is coupled to the at least two matching circuits. The control element is coupled to the communication element and is used to detect the operating frequency band of the communication element to switch the first switching element to couple one of the at least two matching circuits to the decoupling element.

In some embodiments, the antenna system further includes a second switching element disposed on the ground plate and coupled to the at least two matching circuits, and the communication element is coupled to the at least two matching circuits through the second switching element.

In some embodiments, when the control element detects that the operating frequency band of the communication element is a first frequency band, the first switching element and the second switching element are switched to couple with a first matching circuit of the at least two matching circuits, so that the first matching circuit is coupled to the decoupling element, and when the control element detects that the operating frequency band of the communication element is a second frequency band, the first switching element and the second switching element are switched to couple with a second matching circuit of the at least two matching circuits, so that the second matching circuit is coupled to the decoupling element.

In some embodiments, the communication element is a wireless network communication element.

In some embodiments, the first frequency band is 2.4 GHz and the second frequency band is 5 GHz.

In some embodiments, each of the at least two matching circuits includes a filter circuit formed by at least one inductor and at least one capacitor in a T-shaped configuration or a π-shaped configuration.

Another embodiment of the present invention is to provide a decoupling method for an antenna system. The antenna system includes a communication element, and a decoupling element is arranged between two adjacent antennas. The decoupling method includes detecting an operating frequency band of the communication element, switching the switching element to couple a first matching circuit of the at least two matching circuits to the decoupling element when the operating frequency band of the communication element is a first frequency band, and switching the switching element to couple a second matching circuit of the at least two matching circuits to the decoupling element when the operating frequency band of the communication element is a second frequency band.

In some embodiments, each of the at least two matching circuits includes a filter circuit formed by at least one inductor and at least one capacitor in a T-shaped configuration or a π-shaped configuration.

Accordingly, the present application can reduce the current of one antenna from flowing to the other antenna through the coupled ground plate to affect the other antenna by setting a decoupling element between the two antennas. Moreover, this present application also provides a plurality of matching circuits respectively coupled with a switching element for adjusting the electronic length of the decoupling element. Thus, by detecting the operating frequency band of the communication element of the antenna system, the switching element is controlled to select one of the matching circuits to couple with the decoupling element for decoupling according to the detected operating frequency band, thereby improving antenna isolation.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an antenna system according to a preferred embodiment of the present invention.

FIG. 2 is a schematic diagram of an antenna system according to another preferred embodiment of the present invention.

FIG. 3 is a schematic diagram of an antenna system according to another preferred embodiment of the present invention.

FIG. 4A is a schematic diagram of a matching circuit according to a preferred embodiment of the present invention.

FIG. 4B is a schematic diagram of a matching circuit according to another preferred embodiment of the present invention.

FIG. 5 is a schematic diagram showing an antenna plate and a ground plate assembly according to a preferred embodiment of the present invention.

FIG. 6 is a flow chart of a decoupling method according to a preferred embodiment of the present invention.

### DESCRIPTION OF THE EMBODIMENTS

To make the contents of the present disclosure more thorough and complete, the following illustrative description is given with regard to the implementation aspects and embodiments of the present disclosure, which is not intended to limit the scope of the present disclosure. The features of the embodiments and the steps of the method and their sequences that constitute and implement the embodiments are described. However, other embodiments may be used to achieve the same or equivalent functions and step sequences.

Unless otherwise defined herein, scientific and technical terminologies employed in the present disclosure shall have the meanings that are commonly understood and used by one of ordinary skill in the art. Unless otherwise required by context, it will be understood that singular terms shall include plural forms of the same and plural terms shall include the singular. Specifically, as used herein and in the claims, the singular forms “a” and “an” include the plural reference unless the context clearly indicates otherwise.

Because the electronic devices are required to be light, thin, short and small, the space available to dispose antennas on the electronic devices becomes smaller. Moreover, when the distance between two antennas is reduced, the current of one antenna will flow to the other antenna through the coupled ground plate if the two antennas have the same frequency band, which will cause the deterioration of antenna isolation. Therefore, the present invention provides a decoupling element disposed between two antennas to reduce the current of one antenna from flowing to other antennas through the coupled ground plate to affect the other antennas. Moreover, the present application also provides matching circuits to couple with the decoupling element for adjusting the electronic length of the decoupling element. The matching circuits are coupled to a switching element. Accordingly, by detecting the operating frequency band of the communication element of the antenna system, the switching element is switched to select a corresponding matching circuit to couple with the decoupling element for decoupling according to the detected operating frequency band, thereby improving antenna isolation.

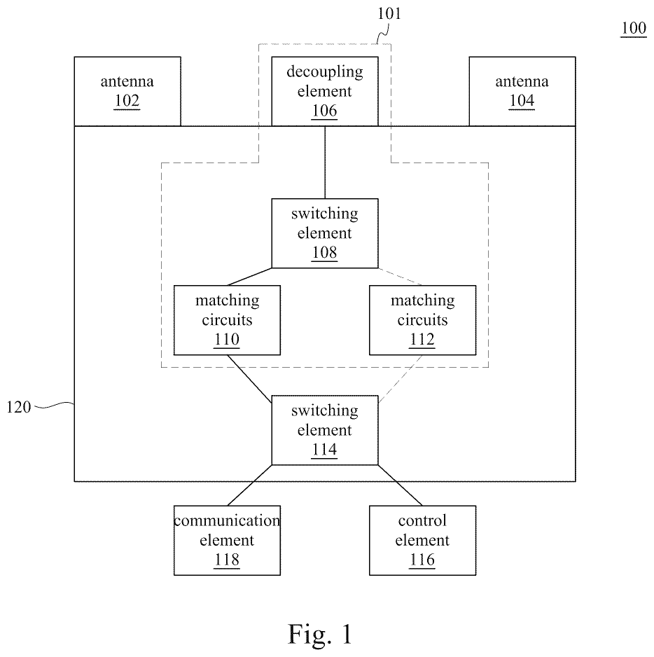

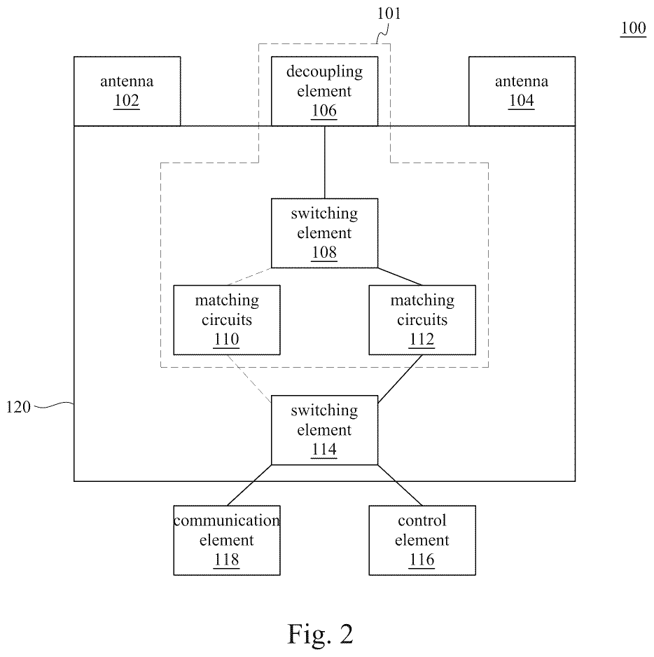

FIG. 1 is a schematic diagram of an antenna system according to a preferred embodiment of the present invention. FIG. 2 is a schematic diagram of an antenna system according to another preferred embodiment of the present invention. In some embodiments, the antenna system 100 is disposed in an electronic device. The antenna system 100 has a decoupling device 101 for improving the isolation between antennas of the antenna system 100. The electronic device is selected from one of a desktop computer, a notebook computer, a tablet computer and a smart phone. However, the present invention is not limited to the above-mentioned electronic devices.

As shown in FIG. 1 and FIG. 2, the antenna system 100 includes a ground plate 120, a decoupling device 101, at least two antennas 102 and 104, a switching element 114, a communication element 118, and a control element 116. The two antennas 102 and 104 are adjacent to each other. The decoupling device 101 is disposed between the two antennas 102 and 104 to provide different decoupling paths for the antennas 102 and 104 according to the operating frequency band of the antenna system 100 to improve the isolation of the antennas 102 and 104. It should be noted that the antenna system 100 having two antennas 102 and 104 is used to illustrate the application in the above embodiment. However, in other embodiments, the antenna system 100 is not limited to two antennas.

In some embodiments, the decoupling device 101 further includes a decoupling element 106, a switching element 108, and at least two matching circuits 110 and 112. The decoupling element 106 is disposed between the two antennas 102 and 104. The decoupling element 106 and the two antennas 102 and 104 are disposed on one side of the ground plate 120 and coupled to the ground plate 120. The switching element 108 and the two matching circuits 110 and 112 are disposed on the ground plate 120. In some embodiments, the decoupling element 106 is used to prevent the current of one antenna from flowing to the other antenna to affect the operation of the other antenna when the two antennas 102 and 104 operate in the same frequency band. In some embodiments, the decoupling element 106 is a metal line segment with a length of one quarter or one half wavelength. However, an antenna system with a multi-band operation function needs a plurality of decoupling elements with different electronic lengths to improve the isolation between antennas in different frequency bands. Therefore, the decoupling element 106 with a single electronic length is not suitable for an antenna system with multi-band operation function. To solve the above problem, the decoupling device 101 of the present invention further includes at least two matching circuits 110 and 112 coupled to the decoupling element 106 via a switching element 108 to provide different decoupling paths to improve the isolation between the antennas. In some embodiments, the switch element 108 is controlled to select one of the two matching circuits 110 and 112 to couple to the decoupling element 106 to adjust the electronic length of the decoupling element 106 to increase the applicable frequency band of decoupling. It is worth noting that only two matching circuits 110 and 112 are used to adjust the path length of the decoupling element 106 in this embodiment. However, in other embodiments, a corresponding number of matching circuits may be configured according to the number of operating frequency bands of the antenna system.

In some embodiments, the control element 116 of the antenna system 100 can detect the operating frequency band of the communication element 118 to control the switching of the switching element 108 in the decoupling device 101 to select one of the two matching circuits 110 and 112 to couple to the decoupling element 106. In some embodiments, the antenna system 100 further includes a switching element 114 disposed on the ground plate 120. The switching element 114 couples the two matching circuits 110 and 112 of the decoupling device 101, the control element 116 and the communication element 118. Therefore, the control element 116 can detect the operating frequency band of the communication element 118 through the switching element 114 to switch the switching element 108 and the switching element 114 to select one of the two matching circuits 110 and 112 to couple with the decoupling element 106 and the communication element 118.

In some embodiments, the communication element 118 can operate in at least two frequency bands, a first frequency band and a second frequency band. In some embodiment, the matching circuit 110 is used to provide a decoupling path when the communication element 118 operates in the first frequency band. The matching circuit 112 is used to provide a decoupling path when the communication element 118 operates in the second frequency band. Accordingly, when the control element 116 detects through the switching element 114 that the communication element 118 of the antenna system 100 is operating in the first frequency band, as shown in FIG. 1, the control element 116 controls the switching elements 108 and 114 to switch to select the matching circuit 110 to couple to the decoupling element 106 and the communication element 118 to improve the isolation between the antennas 102 and 104. On the other hand, when the control element 116 detects through the switching element 114 that the communication element 118 of the antenna system 100 is operating in the second frequency band, as shown in FIG. 2, the control element 116 controls the switching elements 108 and 114 to switch to select the matching circuit 112 to couple to the decoupling element 106 and the communication element 118 to improve the isolation between the antennas 102 and 104. In some implementations, the first frequency band is 2.4 GHz, and the second frequency band is 5 GHz, but the present invention is not limited thereto.

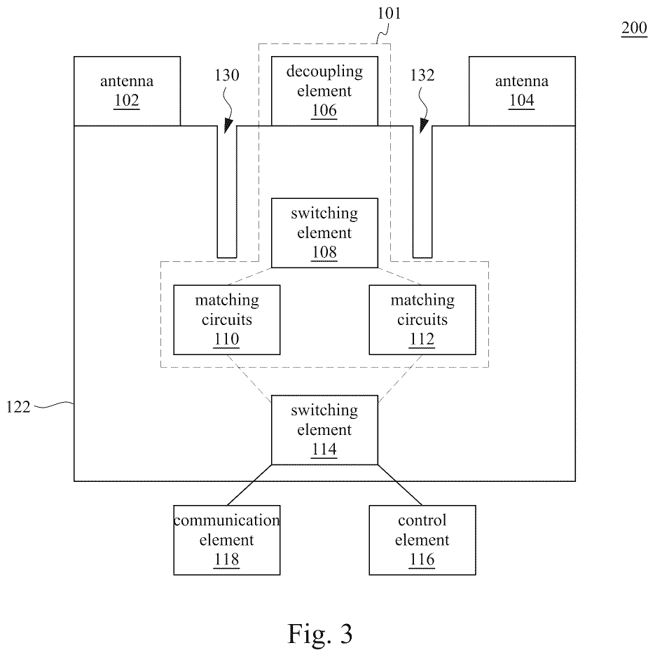

FIG. 3 is a schematic diagram of an antenna system according to another preferred embodiment of the present invention. The ground plate 122 of the antenna system 200 and the ground plate 120 of the antenna system 100 are different. In some embodiments, the ground plate 122 further includes two grooves 130 and 132. The groove 130 is disposed between the antenna 102 and the decoupling element 106, and the groove 132 is disposed between the antenna 104 and the decoupling element 106. Therefore, the decoupling element 106 is separated from the antennas 102 and 104 by the grooves 130 and 132 respectively. In some embodiments, the grooves 130 and 132 may prevent the current flowing from the antennas 102 and 104 into the ground plate 122 from directly flowing to the other antenna before the current reaching the matching circuits 110 and 112 to affect the operation of the other antenna. In some embodiments, by the grooves 130 and 132 to separate the antennas 102 and 104, the current flowing from the antenna 102 into the ground plate 122 can actually reach the matching circuit 110 and then flow into the decoupling element 106 through the switching element 108, and the current flowing from the antenna 104 into the ground plate 122 can actually reach the matching circuit 112 and then flow into the decoupling element 106 through the switching element 108.

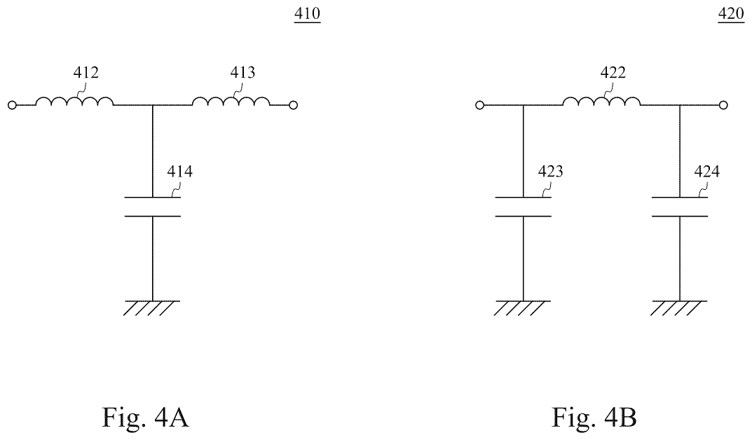

In some embodiments, the matching circuits 110 and 112 are filter circuits, such as L-type filter circuits, π-type filter circuits, or T-type filter circuits. FIG. 4A is a schematic diagram of a T-type filter circuit. The T-type filter circuit 410 includes two inductors 412 and 413 and a capacitor 414. The inductors 412 and 413 are connected in series. One end of the capacitor 414 is electrically connected between the inductors 412 and 413 and the other end of the capacitor 414 is grounded, so as to form a T-type filter structure with the inductors 412 and 413.

FIG. 4B is a schematic diagram of a π-type filter circuit. The π-type filter circuit 420 includes an inductor 422 and two capacitors 423 and 424. One end of the capacitor 423 is connected to one end of the inductor 422, and the other end of the capacitor 423 is grounded. One end of the capacitor 424 is connected to the other end of the inductor 422, and the other end of the capacitor 424 is grounded, so as to form a π-type filter circuit with the inductor 422 and the capacitors 423 and 424.

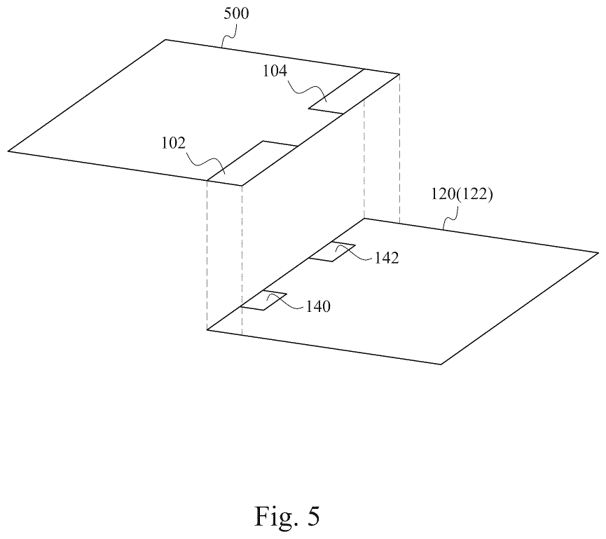

In some implementations, the antenna 102 or 104 and the decoupling element 106 are fed by leaf springs. FIG. 5 is a schematic diagram of an antenna plate and a ground plate assembly according to a preferred embodiment of the present invention. In some embodiments, the two antennas 102 and 104 are disposed on an antenna plate 500, and two leaf springs 140 and 142 are disposed on the ground plate 120 or 122. When the antenna plate 500 and the ground plate 120 or 122 are assembled, the two leaf springs 140 and 142 disposed on the ground plate 120 or 122 will couple the two antennas 102 and 104. Accordingly, the antenna 102 or 104 and the decoupling element 106 are fed by leaf springs 140 and 142.

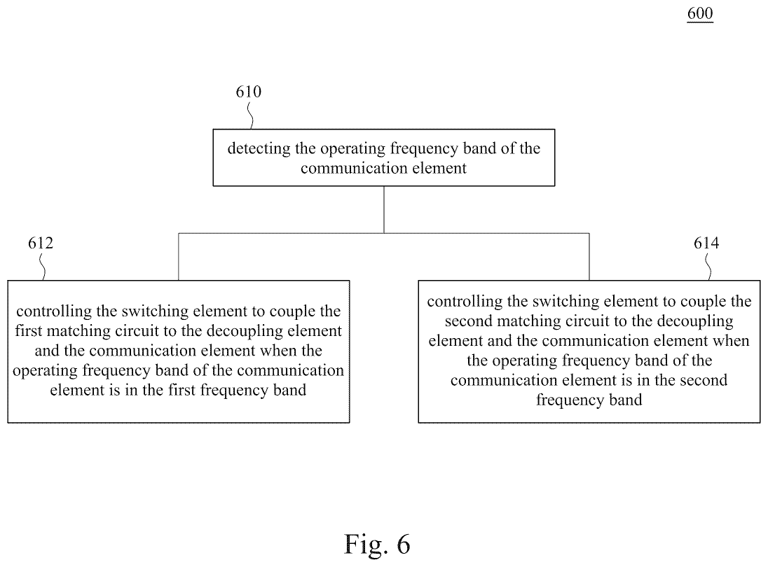

FIG. 6 is a flow chart of a decoupling method according to a preferred embodiment of the present invention. It should be understood that the steps of the decoupling method 600 mentioned in this embodiment, except for those whose order is specifically described, can be adjusted in order according to actual needs, and can even be executed simultaneously or partially simultaneously. Furthermore, in different embodiments, these steps may be adaptively increased, replaced, and/or omitted. Please refer to FIG. 1 to FIG. 3.

The decoupling method 600 of the present invention includes steps 610 to 614. In step 610, the operating frequency band of the communication element is detected. In some embodiments, the control element 116 can detect the operating frequency band of the communication element 118 through the switching element 114. Then, the control element 116 controls the switching elements 108 and 114 to select one of the two matching circuits 110 and 112 to couple with the decoupling element 106 and the communication element 118 according to the detected operating frequency band.

In step 612, when the operating frequency band of the communication element is the first frequency band, the switching element is controlled to couple the first matching circuit to the decoupling element and the communication element. In step 614, when the operating frequency band of the communication element is the second frequency band, the switching element is controlled to couple the second matching circuit to the decoupling element and the communication element. In some embodiments, the first matching circuit, such as the matching circuit 110, is used to provide a decoupling path when the communication element 118 operates in a first frequency band. The second matching circuit, such as the matching circuit 112, is used to provide a decoupling path when the communication element 118 operates in a second frequency band. Accordingly, when the control element 116 detects through the switch element 114 that the communication element 118 of the antenna system 100 operates in the first frequency band, the control element 116 switches the switch elements 108 and 114 to couple the matching circuit 110 to the decoupling element 106 and the communication element 118. When the control element 116 detects through the switch element 114 that the communication element 118 of the antenna system 100 operates in the second frequency band, the control element 116 switches the switch elements 108 and 114 to couple the matching circuit 112 to the decoupling element 106 and the communication element 118.

Accordingly, this present application can reduce the current of one antenna from flowing to the other antenna through the coupled ground plate to affect the other antenna by setting a decoupling element between the two antennas. Moreover, this present application also provides a plurality of matching circuits respectively coupled to a switching element for adjusting the electronic length of the decoupling element. Accordingly, by detecting the operating frequency band of the communication element of the antenna system, the switching element can be controlled to select a corresponding matching circuit to couple with the decoupling element for decoupling, thereby improving antenna isolation.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A decoupling device for an antenna system, comprising:
a ground plate;
a decoupling element disposed between two adjacent antennas, wherein the decoupling element and the two adjacent antennas are coupled to the ground plate;
a switching element disposed on the ground plate and coupled to the decoupling element; and
at least two matching circuits disposed on the ground plate and coupled to the switching element respectively, wherein the switching element is switched according to an operating frequency band of a communication element to couple one of the at least two matching circuits to the decoupling element.

2. The decoupling device as claimed in claim 1, wherein the ground plate comprises two grooves, and the decoupling element is separated from the two adjacent antennas by the two grooves.

3. The decoupling device as claimed in claim 1, wherein each of the at least two matching circuits comprises a filter circuit formed by at least one inductor and at least one capacitor in a T-shaped configuration or a π-shaped configuration.

4. The decoupling device as claimed in claim 1, wherein the two adjacent antennas are disposed on an antenna board, and when the antenna board and the ground plate are assembled, the two adjacent antennas are coupled to the ground plate through two springs on the ground plate.

5. The decoupling device as claimed in claim 1, further comprising a control element for detecting the operating frequency band of the communication element.

6. The decoupling device as claimed in claim 5, wherein when the control element detects that the operating frequency band of the communication element is a first frequency band, the switching element is switched to couple a first matching circuit of the at least two matching circuits to the decoupling element, and
when the control element detects that the operating frequency band of the communication element is a second frequency band, the switching element is switched to couple a second matching circuit of the at least two matching circuits to the decoupling element.

7. An antenna system, comprising:
a ground plate;
at least two adjacent antennas coupled to the ground plate;
a decoupling element coupled to the ground plate and disposed between the at least two adjacent antennas;
a first switching element disposed on the ground plate and coupled to the decoupling element;
at least two matching circuits disposed on the ground plate and coupled to the first switching element respectively;
a communication element coupled to the at least two matching circuits; and
a control element coupled to the communication element for detecting an operating frequency band of the communication element to switch the first switching element to couple one of the at least two matching circuits to the decoupling element.

8. The antenna system as claimed in claim 7, further comprising a second switching element disposed on the ground plate and coupled to the at least two matching circuits, wherein the communication element is coupled to the at least two matching circuits through the second switching element.

9. The antenna system as claimed in claim 8, wherein when the control element detects that the operating frequency band of the communication element is a first frequency band, the first switching element and the second switching element are switched to couple with a first matching circuit of the at least two matching circuits, so that the first matching circuit is coupled to the decoupling element, and
when the control element detects that the operating frequency band of the communication element is a second frequency band, the first switching element and the second switching element are switched to couple with a second matching circuit of the at least two matching circuits, so that the second matching circuit is coupled to the decoupling element.

10. The antenna system as claimed in claim 9, wherein the communication element is a wireless network communication element.

11. The antenna system as claimed in claim 10, wherein the first frequency band is 2.4 GHz and the second frequency band is 5 GHz.

12. The antenna system as claimed in claim 7, wherein each of the at least two matching circuits comprises a filtering circuit formed by at least one inductor and at least one capacitor in a T-shaped configuration or a π-shaped configuration.

13. A decoupling method for an antenna system, wherein the antenna system comprises a communication element, a decoupling element disposed between two adjacent antennas, a switching element coupled to the decoupling element, and at least two matching circuits coupled to the switching element respectively, the method comprising:
detecting an operating frequency band of the communication element;
switching the switching element to couple a first matching circuit of the at least two matching circuits to the decoupling element when the operating frequency band of the communication element is in a first frequency band; and
switching the switching element to couple a second matching circuit of the at least two matching circuits to the decoupling element when the operating frequency band of the communication element is in a second frequency band.

14. The decoupling method as claimed in claim 13, wherein each of the at least two matching circuits comprises a filter circuit formed by at least one inductor and at least one capacitor in a T-shaped configuration or a π-shaped configuration.
